(19) United States
(12) Patent Application Publication
(10) Pub. No.: US 2018/0035094 A1
(43) Pub. Date: Feb. 1, 2018

(54) SYSTEM AND METHOD FOR INTEGRATING DIGITAL MEDIA FEATURES WITH A MEMORIAL

(71) Applicant: Bryan Evans, Waterloo, IL (US)

(72) Inventor: Bryan Evans, Waterloo, IL (US)

(21) Appl. No.: 15/224,631

(22) Filed: Jul. 31, 2016

(51) Int. Cl. H04N 9/87; H02S 20/10; G06F 3/041; F03D 9/00; H02J 7/02; G06F 1/18; H02S 40/38

(52) U.S. Cl. CPC H04N 9/87; G06F 1/181; H02S 20/10; H02S 40/38; F03D 9/002; H02J 7/022; G06F 3/0412

(57) ABSTRACT

Embodiments of the invention are directed to a digital memorial incorporating various forms of video and audio media presentation. In one embodiment, the digital memorial combines traditional burial site memorial features with present day computer-related technology in order to expand the features and utility of a memorial for remembering and paying tribute to the lives of deceased individuals. Video and audio features are aesthetically integrated with a memorial, such that a central processor and supporting hardware are discreetly and securely housed within the memorial structure.

### CROSS-REFERENCE TO RELATED APPLICATION

This application claims the benefit of U.S. Provisional Application No. 62/287,835, filed Jan. 27, 2016.

### FIELD

This disclosure relates to a structural memorial having integrated media presentation capabilities.

### BACKGROUND

Historically, people across cultures have embraced traditions and artifacts to mourn the passing of loved ones and public figures. These traditions are generally ceremonial in nature, being rooted in spirituality and a belief that ceremonies have eternal implications for the deceased. Other practices are geared toward memorializing the deceased, which is for the benefit of the living. Indeed, ceremonies and memorials are integral for helping the living cope with the loss of public figures and loved ones. Memorials are valued for firmly rooting memories of the deceased within the minds of the living and establishing a testament of the deceased for future generations.

Most western cultures practice ceremonial and memorial traditions that include, for example, visitation, wake, and funeral for the deceased. Burial of the dead is a long-held tradition in the west, while cremation has been practiced by many eastern cultures. However, due to environmental concerns and the increasing costs of burial, cremation is gaining favor among many western cultures. Cremation has been adapted to fit within the long-held traditions of western cultures. Increasing numbers are now electing cremation, but without abandoning long-standing burial traditions. This is made tolerable by only substituting casket with urn, while maintaining other long-standing ceremonial and memorial traditions.

Over time, traditions tend to remain mostly unchanged, even in times of great technological and cultural change. A desire for certainty in the midst of accelerating scientific and technological progress seems to reinforce adherence to traditions within societies. This would explain why so many find solace and emotional healing in visiting shrines and memorials. It may also explain why technology has largely failed to proportionally influence traditions relating to mourning and remembering lost loved ones, even when certain technologies may benefit those traditions. For example, gravestones are certainly effective in passing down very limited information about past generations. However, that information is only limited due to the technology that was available when these traditions began. Only so much information can be carved into the face of a gravestone.

Today, massive amounts of information may be stored digitally at very low cost. Where a traditional gravestone is able to record very general information (e.g., name, birthdate, date of death, names of family members, occupation), there now exists means of storing every detail of one's life within a space of a small coin. Moreover, digital forms of information may be quickly duplicated and securely stored for unknown centuries.

If a gravestone or any other memorial was being invented today for the first time, it would hold little resemblance to the memorials that continue to be constructed within the confines of tradition. As previously discussed, cremation has arguably improved the burial process without disrupting the ceremonial nature. Similarly, digital technology may improve the remembrance process without disrupting the memorial nature.

For these reasons and others that will become obvious through reading this disclosure, there is a need for a more sensory-based system for remembrance that incorporates audio and visual media presentation. A method for providing a more permanent and complete record of the lives of the deceased is also needed, such that present and future generations may form and/or maintain accurate and meaningful knowledge of those individuals. Moreover, there is a need for a system and method for providing sound, images, and moving images to bring comfort and healing to the living, even long after the loss of a loved one.

### SUMMARY

A system and method is disclosed for integrating digital sound and imagery with more traditional memorials, including gravestones, markers, statues, plaques, structures, and the like. More specifically, a digital memorial comprising an integrated processing unit, network adaptor, display device, and audio output device is disclosed, wherein the audio output device and/or display device is readily operable for playback of recorded information relating to the life of a deceased person or animal.

In various embodiments, a digital memorial is configured to receive and store digital images and audio in the form of computer media files, wherein an integrated data storage device is updated with uploaded data for subsequent playback. Those of ordinary skill in the art will appreciate that memory for storing such information may take the form of any know digital data storage architecture including local and off-site data stores, as will be described in greater detail herein.

In one embodiment, the digital memorial is configured to maintain a primary audio and/or visual library as provided by an administrator who may be a family member of the deceased, a worker, or any other trusted third-party who is provided access rights to provide and/or modify stored information corresponding to a specific memorial. Also, while full access rights may be granted to one or more select administrators, secondary credentials may be provided to selected individuals for limited actions such as, for example, adding a photo, video clip, or audio file to a media presentation.

In various embodiments, the digital memorial is configured to maintain large amounts of digital information within an on-board solid state data storage device. The digital memorial may be configured with any amount of computer memory and data storage. The digital memorial is also configured to house and/or maintain a connection to microcontroller or microprocessor to manage data storage and retrieval.

In various embodiments, the microcontroller/microprocessor is configured to perform operations to transform data from a first form to a second form. Such transformations may include, for example, encoding, decoding, encrypting, decrypting, and formatting the data in accordance with predefined standards, preferences, and system requirements.

In various embodiments, a power supply provides and manages electricity load requirements in accordance with various hardware and software configurations of the disclosed digital memorial. The power supply may be a disparately located utility, which is known to provide electricity by way of above ground and/or underground cabling. A power source for managing all or a subset of the digital memorial's power needs may be a local source, which generates renewable forms of energy from the sun or wind, for example. Accordingly, the digital memorial may include one or more batteries for storing any energy when the amount of electricity generated exceeds the load requirements of the digital memorial. As such, stored energy may be utilized in times where the electrical requirements of the digital memorial exceed the rate of electrical generation.

In various embodiments, a digital memorial includes a memorial structure having an integrated housing. A central processor is positioned within the housing and a display device is in communication with the central processor and is also positioned within the housing. The housing includes a data storage device that is in communication with the central processor and a power supply that is configured to provide electric current to the central processing unit, the display device, and the data storage device.

In one embodiment, a computer-implemented method includes the steps of receiving, at a central processor, an instruction to read a data file, wherein the instruction is indicative of a user selection. A data file is retrieved from a data storage device, wherein the data file includes digital media. The central processor processes the digital media to create output data, the output data including audio data and/or video data. The central processor writes the output data to a display device when the output data includes the video data and writes the output data to an audio device when the output data includes the audio data.

In this respect, before explaining embodiments of the invention in greater detail, it is to be understood that the invention is not limited in its application to the details of construction and to the arrangements of the components set forth in the following description or illustrated in the drawings. The disclosed system and method may take forms and be carried out in various ways. Further, it is to be understood that the phraseology and terminology employed herein are for the purpose of description and should not be regarded as limiting.

### BRIEF DESCRIPTION

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

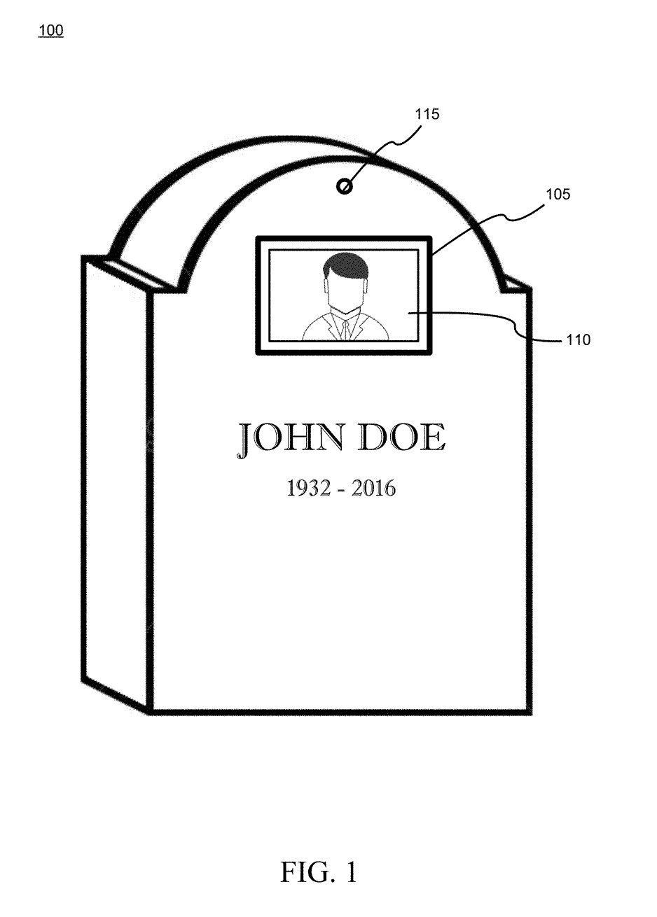

FIG. 1 is a perspective front view of an exemplary digital memorial, in accordance with various embodiments;

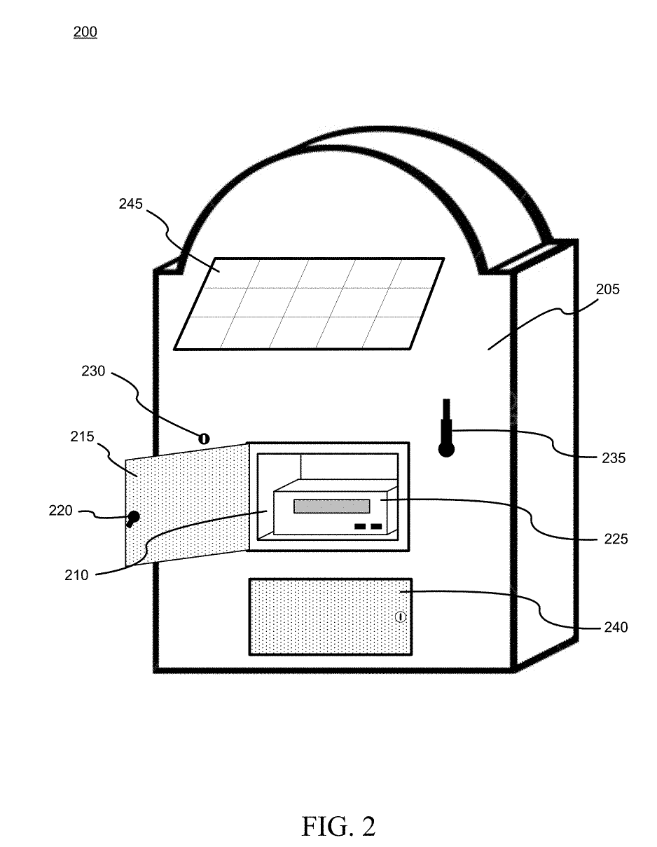

FIG. 2 is a perspective back view of an exemplary digital memorial, in accordance with various embodiments; and

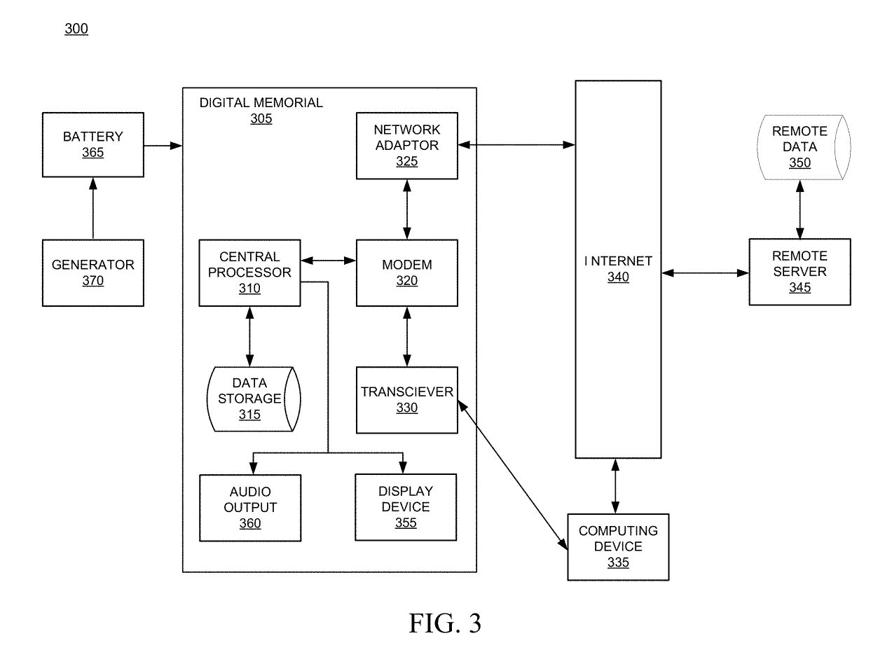

FIG. 3 is a system diagram showing a central processor with interconnected components, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The present disclosure provides a system, method, and computer program product for recording, maintaining, and executing desired audio and visual type operations. In various embodiments, the digital memorial facilitates sensory based presentation of information pertaining to a person or persons to be memorialized. The disclosed digital memorial relates generally to memorial structures and devices such as, for example, gravestones, grave markers, plaques, plates, signs, statues, sculptures, and any other form of physical grave identification. Specifically, the disclosed digital memorial stores and executes digital data files to produce “on-demand” music, sound effects, voices, still photos, video, animation, and the like (i.e., “multimedia”).

Systems, methods and computer program products are described relative to corresponding figures. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

FIG. 1 is a perspective front view of an exemplary digital memorial, in accordance with various embodiments. The digital memorial is shown in the form of, and described relative to, a known traditional gravestone. However, this is for explanation only and those of ordinary skill in the art will appreciate that the disclosed features may be embodied in any type and form of memorial or similar device.

The memorial structure 100 may be manufactured, constructed, or formed of any material known in the art including, for example, stone, marble, concrete, ceramic, bronze, metal alloys, and the like. As used herein, “memorial structure” is used to describe the overall physical form a memorial in the broadest sense. In other words, use of the term “memorial structure” herein does not alone limit the memorial to any specific type, size, method of manufacture, material of manufacture, and the like.

In one embodiment, the memorial structure 100 may be formed using known methods and processes such as carving, casting, molding, constructing, and sculpting. As will become apparent through this disclosure, the memorial structure 100 as disclosed, is created by way of non-typical or modified processes in order to suitably accommodate the disclosed components. For example, if a memorial structure 100 is cut and carved from a solid marble block, additional steps may be needed to create openings for housing the disclosed processing unit, display device, and audio output device.

While the disclosed system may be incorporated within most types of memorial structures, design considerations should account for exposure and aesthetics. For example, positioning a display device 110 and/or processing unit too low on the memorial structure may lead to added risk of contamination and damage from environmental factors. Any number of variables may exist relative to specific implementations, which may influence the shape and material selected for the memorial structure.

In one embodiment, the front (or visitor facing side) of the memorial structure 100 includes a display window 105 that is sized in accordance with display device 110 dimensions. As such, the display device 110 should be clear with sufficient backlighting when viewed from differing angles and under changing lighting conditions. In one embodiment, the display device 110 includes a capacitive touch technology, allowing a visitor to interact with a media presentation by way of touch.

In one embodiment, media playback features are made available when a central processor receives a wake signal. In a power saving mode, the central processor may be configured to enter a sleep state, where only a minimal power load is needed to monitor events. A motion sensor 115 may be configured to invoke a wake command when motion is detected within a preset perimeter of the memorial structure 100. As such, the central processor, display device, and audio output device may consume very minimal electrical power until such time that a visitor moves to and remains within three feet of the digital memorial, for example. Those of ordinary skill in the art will appreciate that motion sensor 115 may comprise one of several known types of motion sensing devices.

FIG. 2 is a perspective back view of an exemplary digital memorial, in accordance with various embodiments. In one embodiment, the back facing side 205 of the memorial structure 200 is opposite the display facing side, as described with reference to FIG. 1. The back facing side 205 of the memorial structure 200 includes an access point 210 for accessing and maintaining the central processor 225 and/or supporting components. An access point 210 includes a secure door or lid that serves to seal any delicate and sensitive electronic components within the body of the memorial structure 200. To protect the central processor 225 and supporting components from theft and/or vandalism, the lockable cover 215 includes a locking mechanism 220, in accordance to various embodiments.

FIG. 3 is a system diagram showing a central processor with interconnected components, in accordance with various embodiments. While specific hardware elements are herein described relative to the disclosed digital memorial, those of ordinary skill in the art will appreciate that a number of additional hardware and/or software elements may be included without departing from the scope of this disclosure. The hardware elements, their interconnections, and orders of operation are presented for explanation only.

In various embodiments, the system 300 comprises a central processor 310 including a data storage device 315, as well as any number of additional microprocessors or similar (not shown). The digital memorial 305 includes a display device 355 to display digital photos and digital video, an audio output device 360 to generate sounds, a data storage device 315, which is used to store various types of multimedia data files including digital images and video files. The digital memorial 305 also comprises a renewable power generator 370 and a battery 365, in various embodiments.

In one embodiment, the central processor 310 in the form of a computer or microcontroller unit, manages many of the features disclosed herein. The central processor 310 may comprise a single removable unit with integrated central and supporting components. For example, the central processor 310 may comprise a tablet computing device, wherein the microprocessor board, memory, battery, and display are integrated within a single casing.

With occasional referring to FIG. 2, the central processor 310 may also comprise disparate components and devices that are conductively or wirelessly interconnected. For example, the digital memorial 305 may include separate cubbies or slots that are suitably sized for receiving and maintaining individual components for carrying out the disclosed features. As described in greater detail herein, digital memorial 305 components may include a central processor 310, a data storage device 315, display device 355, audio output device 360, battery 365, and etc.

In one embodiment, the central processor 310 includes, and is configured to access, data storage device 315 for storing digital information by way of one or more connections to a remote server 345 and/or remote data storage device 350. Any data storage or memory device discussed herein may be provided by way of a mechanical hard-drive and/or a non-volatile block storage memory structure. The data storage device 315 may be distally attached to the digital memorial 305 and accessible by way of wireline and/or wireless connection between the central processor 310 and a data storage device 315. For example, multimedia content may be stored and maintained by a remote server 345, which is maintained by a third-part provider and accessible as needed to retrieve, process, and format raw digital information for output to a display device 355 and/or audio output device 360.

In one embodiment, the central processor 310 includes a network adaptor 325 for connecting to a local area (LAN) or a wide-area (WAN) network, such as the Internet 340. Accordingly, multimedia data may be stored locally (i.e., data storage device 315), remotely (i.e., remote data storage device 350), or by way of a combination thereof. Networking hardware may also include a modem 320 for connecting to a remote server 345 or computing device 335, by way of either LAN or WAN. In one embodiment, the modem 320 may be a wireless modem that is configured to connect to a network (e.g., Internet 340) wirelessly using cellular data protocols or similar. The modem 320 may instead/also be configured for wireline connections with a network.

The central processor 310 includes an input means for receiving digital data. In one embodiment, the input means includes a data port 230 (e.g., USB) that is conveniently positioned, yet is hidden from view and/or is secured behind a removable panel within the memorial structure 200. For example, a data port 230 for downloading media files from and/or uploading to a computing device 335 (e.g., notebook computer, tablet computer, etc.) being positioned on the back facing side 205 or behind a removable and lockable cover 215.

In various embodiments, the central processor 310 includes a radio transceiver 330 for facilitating communications with a computing device 335 by way of a wireless protocol such as, for example, Bluetooth or WiFi. A wireless connection between the central processor 310 and computing device 335 may allow configuration, media uploading, and maintenance tasks to be performed on the digital memorial 305 without requiring establishment of a physical connection (e.g., connecting a USB cord). In one embodiment, a transceiver antenna 235 is positioned on an exterior portion of the memorial structure 200 to maintain reliable wireless data connections with a computing device 335. However, those of ordinary skill in the art will appreciate that a chip-based antenna or any other known antenna device may be incorporated within the memorial structure 200.

In various embodiments, the digital memorial 305 includes a display device 355 that is configured for wireline or wireless communication with the central processor 310. The display device 355 may comprise an LCD display configured to display still images and video within a viewable area of the memorial structure 200. For example, the digital memorial 305 may include a 7″ or larger display device 355 that is inset from the face of the digital memorial, such that displayed media is conveniently viewable by one or more visitors. However, those of ordinary skill in the art will appreciate that any size and/or configuration of display device 355 may be incorporated into the digital memorial 305 without departing from the scope of the invention. The display device 355 selection may be restricted only by electrical load requirements and/or specific structural features of the memorial structure 200.

In one embodiment, the digital memorial 305 is configured to interact with a viewer/visitor by way of a control device, such as a button and/or touch screen display. An LCD, or similar, display device 355 may be configured with capacitive touch sensors to receive user input from a visitor. Further, the digital memorial 305 may include any number of buttons, dials, and switches for providing visitor input to the central processor 310.

Those of ordinary skill in the art will appreciate that any means known for interacting with a personal computing device may be incorporated without departing from the scope of this disclosure. For example, a digital memorial 305 may include a touch screen and a microphone for receiving touch and/or verbal commands from a visitor, such that the central processor 310 processes commands and invokes response by the central processor 310.

In one embodiment, the digital memorial 305 includes an audio output device 360 for generating recorded audio in the form of, for example, music, sound effects, and voice. The audio output device 360 may be configured to withstand varying weather conditions including heat, cold, wind, and moisture. One or more audio output device(s) 360 may be discreetly positioned on the memorial structure, such that they are not visible, while also maintaining an ability to generate and project clear and audible sound to one or more visitors.

In various embodiments, a client interface is provided by way of locally executable software or a remotely served web site. The client interface may expose various features of the central processor 310 to an administrator or other authorized third-party. Feature configurations may be made available for view only or for modification. Modifiable and/or viewable features may include, for example, central processor 310 status, stored media content, number of visitors interacting with the corresponding digital memorial 305, and the like.

A client interface, as well as any additional interface disclosed herein, may be secured from access by any means known in the art for protecting limited access content. Moreover, access rights may be assigned to users by an administrator or memorial owner and access rights may govern individual read and write privileges for an assigned user.

The central processor 310, display device 355, audio output device 360, and additional auxiliary components (e.g., LED lighting) may be supplied sufficient electrical current in accordance with various embodiments. In one embodiment, the power requirement of the digital memorial 305 is fulfilled by a typical above or below-ground electrical line.

In various embodiments, the digital memorial 305 may receive harvested electricity from a solar panel 245 or wind turbine (not shown), which may be used to provide functional current to the digital memorial 305. Accordingly, a battery 365 may be housed behind a lockable cover 240 in the memorial structure 200. Battery charge may be maintained by the renewable source, wherein the solar panel 245 or wind turbine is integrated with the memorial structure 200. As such, one or more batteries receive a charging current from an attached generator (e.g., solar panel 245) when the wattage produced exceeds the draw of the central processor 310, display device 355, audio output device 360, and auxiliary components (e.g. lighting). When the load of the digital memorial 305 exceeds the generated wattage (e.g., nighttime, calm wind, overcast, etc.), then the stored battery power provides the deficit power to ensure a constant power source.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.”

Where a phrase similar to “at least one of A, B, and C” or “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A digital memorial comprising:
a memorial structure having an integrated housing;
a central processor positioned within the housing;
a display device in communication with the central processor and positioned within the housing;
a data storage device in communication with the central processor and positioned within the housing; and
a power supply configured to provide electric current to the central processing unit, the display device, and the data storage device.

2. The digital memorial of claim 1, wherein the memorial structure is at least one of: a gravestone, a grave marker, a plaque, a statue, or a closed structure.

3. The digital memorial of claim 1, Further comprising a renewable energy generator

4. The digital memorial of claim 1, wherein the display device is a flat panel display.

5. The digital memorial of claim 1, wherein the display is a touchscreen.

6. The digital memorial of claim 1, wherein the data storage device comprises at least one of: DDR-SDRAM, DDR2-SDRAM, DIMM, DRAM, EDO, FPM, SDRAM, LIMM, RDRAM (RAMBUS), RIMM, SIMM, or SODIMM.

7. The digital memorial of claim 1, wherein the power supply includes a rechargeable battery.

8. The digital memorial of claim 1, further comprising a renewable energy generator having a wired connection with the power supply.

9. The digital memorial of claim 7, wherein the renewable energy generator is at least one of: a solar panel or a wind turbine.

10. The digital memorial of claim 1, further comprising a modem in communication with the central processor

11. The digital memorial of claim 10, wherein the modem is configured to communicate with a remote computer over a wireline or wireless network.

12. The digital memorial of claim 1, further comprising a radio transceiver configured to at least one of: send or receive data over at least one of a LAN or WAN.

13. A computer-implemented method comprising:
receiving, at a central processor, an instruction to read a data file, wherein the instruction is indicative of a user selection;
retrieving, from the central processor, the data file from a data storage device, wherein the data file includes digital media;
processing, by the central processor, the digital media to create output data, the output data including at least one of: audio data or video data;
writing, by the central processor, the output data to a display device when the output data includes the video data; and
writing, by the central processor, the output data to an audio device when the output data includes the audio data.

14. The computer-implemented method of claim 13, wherein the central processor comprises at least one of: a microcontroller or a microprocessor.

15. The computer-implemented method of claim 13, wherein the data storage device is located at a remote server.

16. The computer-implemented method of claim 13, wherein the data file is retrieved from a remote server by way of at least one of: a LAN or WAN.

17. The computer-implemented method of claim 13, wherein the data file is retrieved from a computing device by way of a wireless connection.

18. The computer-implemented method of claim 13, wherein the wireless connection comprises a Bluetooth connection.

19. The computer-implemented method of claim 13, wherein the central processor receives electrical current from a power source.

20. The computer-implemented method of claim 19, wherein the power source including receives the electrical current from at least one of: a solar panel or a wind turbine.
